(19) United States
(12) Patent Application Publication
(10) Pub. No.: US 2010/0196586 A1
(43) Pub. Date: Aug. 5, 2010

(54) FOODSTUFF COMPOSITION TO IMPROVE DIGESTIBILITY OF FOODSTUFF LIPIDS

(75) Inventors: Martine Armand, Auriol (FR); Gérard Pieroni, Marseille (FR)

Correspondence Address: MATTHIAS SCHOLL, 14781 MEMORIAL DRIVE, SUITE 1319, HOUSTON, TX, 77079, US

(73) Assignees: ISL-INNOVATION SANTE LIPIDES, MARSEILLE (FR); INSTITUT NATIONAL DE LA SANTE ET DE LA RECHERCHE MEDICALE (INSERM), Paris (FR)

(21) Appl. No.: 12/668,783

(22) PCT Filed: Jul. 18, 2008
(86) PCT No.: PCT/FR2008/001062

§ 371 Date: Jan. 12, 2010

(30) Foreign Application Priority Data
Jul. 20, 2007 (FR) 0705294

(51) Int. Cl. A23L 1/30

(52) U.S. Cl. 426/648

(57) ABSTRACT

The invention relates to human or animal food and more particularly to a food composition for improving digestibility of foodstuff lipids, comprising one or more lysophospholipids and/or phospholipids. The invention further relates to a foodstuff containing said food composition and a method for improving the digestibility of foodstuff lipids.

The present invention relates to the field of human or animal food and more particularly to a foodstuff composition for improving digestibility of foodstuff lipids, comprising one or more lysophospholipids and/or phospholipids, selected from lysophosphatidylinositol, oleyl lysophosphatidic acid, lysophosphatidylserine, egg-derived lysophosphatidylcholine and phosphatidylethanolamine DHA.

It is also one of the aims of the present invention to have a food comprising said foodstuff composition according to the invention.

The invention also concerns a method for improving the digestibility of foodstuff lipids.

The process of digestion/absorption is complex but extremely efficient in the healthy subject with 98% absorption of digested triglycerides, 20-60% for cholesterol and 50-80%, 80-90% and 50% for vitamins D, A and E, respectively.

In subjects with a physiological reduction of gastric functioning (ageing) or pancreatic functioning (reversible in full-term or premature newborn infants, or irreversible in old age) or pancreatic insufficiency of pathological origin (chronic pancreatitis, cystic fibrosis), the bioavailability of lipids is, in contrast, greatly reduced. The leading causes are insufficient quantity and/or poor activity of endogenous lipases, as well as poor absorption linked to a phospholipid and bile salt deficiency.

In newborn infants, pancreatic immaturity leads to secretion of non-optimal pancreatic lipase and bicarbonate ions, and the digestion of lipids in the duodenum is greatly reduced due to a lack of lipase and the acidic pH of the environment.

On the other hand, hepatic immaturity leads to insufficient secretion of bile salts useful for digestion but also for the absorption of lipids (duodenal concentration of bile salts: 2 to 3.5 mM). However, bile salt stimulated lipase (BSSL), a lipase present in breast milk, compensates for the absence or weak activity of pancreatic lipase if the newborn infant is fed with its mother's milk.

In the case of cystic fibrosis, the irreversible destruction of the pancreas leads to a total absence of pancreatic lipase and bicarbonate ion secretion with a very acidic pH in the duodenal environment that alters, due to their precipitation, the function of the bile salts which are nevertheless secreted in quite normal quantities unless associated hepatic damage is present.

The same hypothetical case is observed in the case of chronic pancreatitis. It is noted, however, that while the levels of pancreatic lipase are very low in newborn infants and in the case of pancreatic insufficiency of pathological origin, gastric lipase is secreted in identical or higher quantities than in healthy subjects.

Until now, approaches aimed at correcting the problems of poor digestion of dietary lipids in subjects suffering from cystic fibrosis or chronic pancreatitis have resulted most often in the administration of a supplement of lipolytic enzymes from pig pancreas.

However, enzymatic supplements based on powder of pig pancreas are not always effective for several reasons: 1) destruction of the enzymes during their passage into the stomach due to the acidic pH; 2) problem of delivery in the case of gastro-protected preparations as the microspheres only dissolve at a pH greater than 5.5, a pH that is not always reached in the duodenum; 3) intraduodenal pH non-favorable to optimal action of pancreatic lipase; and 4) secondary effects such as the destruction of the colon mucosa following the administration of too high doses of enzymatic supplement.

To resolve some of these problems, antacids can be administered at the same time to patients, which can protect enzymatic supplements sensitive to degradation giving a more adequate intraduodenal pH; for this, clear recommendations as to the maximum dose of supplements have been defined (pancreatic lipase dose fixed at 4000 IU/g of digested lipids without exceeding 10,000 IU/kg/day). Furthermore, bicarbonate ions are added into certain enzymatic preparations in order to create a pH microenvironment adequate for the activity of enzymes (pancrelipase, Pancrecarb, Digestive Care, Bethlehem, Pa., USA) which can reduce steatorrhea by one third.

New sources of lipases, either microbial (Altu-135, Altus Pharmaceuticals, Cambridge, Mass., USA), or recombinant dog gastric lipase (Merispase, Meristem, Clermont-Ferrand, France), have been tested very recently in subjects suffering from cystic fibrosis.

Microbial lipase increases the absorption of lipids from 21 to 33% following administration of 25,000 to 100,000 units per meal. The administration of recombinant gastric lipase alone (600 mg/day) increases the rate of absorption of lipids from 28% without supplement to 50%; this absorption level is increased by 17% when recombinant gastric lipase is administered together with pancreatic extracts in 7 of the 11 patients studied.

The results obtained are very variable due to large interindividual physiological differences. To improve the absorption of lipids in pancreatic insufficiency cases, the effective dose and type of supplement to prescribe can only be determined with knowing the real needs of the patients.

In newborn infants fed with breast milk substitutes, the use of an enzymatic supplement based on breast milk lipase (BSSL) has been considered by certain authors.

This new generation of enzymatic supplements is still only in the testing phase and is therefore not operational, despite very promising advances.

The development of alternative strategies must therefore be carried out in parallel. In this respect, for example, in the case of cystic fibrosis, the prescription of pancreatic extracts is part of the clear recommendations from the French National Authority for Health. However, the use of such extracts is not without problems in terms of the coordination between the time that the supplements are taken and the digestion of the lipids from the meal (Schall et al., J. Pediatr. Gastroenterol. Nutr. 2006; 43: 651-9).

Indeed, among the problems that can be shown, is the general fact that the pancreatic extracts of lipolytic enzyme sources cannot be combined with foodstuff sources of lipids without initiating undesired lipolysis of the lipids leading to a degraded product unsuitable for consumption.

It is therefore necessary that research must continue on more suitable solutions for improving the digestibility of foodstuff lipids in subjects who require it.

It is one of the aims of the present invention to supply a simple and effective method for improving the digestibility of lipids that overcomes the problems associated with the prior art solutions. Dietary phospholipids, and those secreted endogenously, could play a significant role in the digestibility of foodstuff lipids (Fa\acute{v}e et al., Cellular and Molecular Biology 2004; 50(7): 815-31) and in their absorption (Tso P. In Physiology of the Gastrointestinal tract, Jonhson L R (ed), Raven Press, New York, 1994, pp 1867-1908)).

The inventors have studied different mixtures of phospholipids but also lysophospholipids in order to specify the most suitable type and mixture of these molecules to improve the digestibility of foodstuff lipids. In an unexpected way, lysophospholipids, which are only present in trace amounts in foodstuff or secreted phospholipids, are much more effective at improving lipolysis of lipids.

Among the different molecules tested, the inventors have shown the quite particular properties of lysophosphatidylinositol, oleyl lysophosphatidic acid, lysophosphatidylserine, egg-derived lysophosphatidylcholine and phosphatidylethanolamine DHA in their abilities not only to allow good emulsification of lipids but also to promote lipolysis of the emulsions that contain them.

In particular, in a totally unexpected way, in the presence of the compounds of the invention, some lipidic emulsions not usually very hydrolysable by weakly active gastric lipases, show hydrolysis rates quite comparable to those measured in the presence of human gastric lipase with normal activity, i.e., activity comparable to that of the majority of the population having normal digestion.

It is on the basis of these results that the inventors propose the use of lysophosphatidylinositol, oleyl lysophosphatidic acid, lysophosphatidylserine, egg-derived lysophosphatidylcholine and phosphatidylethanolamine DHA in the preparation of a foodstuff composition aimed at improving the digestibility of lipids.

As shown in the examples, the study of the impact of numerous natural phospholipids and lysophospholipids on the efficacy of lipolysis in an in vitro model close to physiological conditions has allowed the particular properties of lysophosphatidylinositol, oleyl lysophosphatidic acid, lysophosphatidylserine, egg-derived lysophosphatidylcholine and phosphatidylethanolamine DHA to be shown in terms of their abilities of allowing, on the one hand, good emulsification of lipids but also of promoting their lipolysis.

Thus, lysophosphatidylinositol, oleyl lysophosphatidic acid, lysophosphatidylserine, egg-derived lysophosphatidylcholine and phosphatidylethanolamine DHA not only allow the lipidic emulsion to have the structure most suitable for being hydrolyzed, but also make the practically inactive gastric lipases fully functional.

Consequently, the inventors have developed a foodstuff composition useable either alongside food, or as a component of at least one food to improve the digestibility of foodstuff lipids.

Thus, as its primary aim, the invention concerns the use of lysophosphatidylinositol, oleyl lysophosphatidic acid, lysophosphatidylserine, egg-derived lysophosphatidylcholine and phosphatidylethanolamine DHA as ingredients usable as a supplement aimed at improving the digestibility of lipids.

As used herein, an improvement of the digestibility of foodstuff lipids is defined as an increase in the rate of hydrolysis of dietary lipids compared to the rate of hydrolysis without the composition according to the invention.

Lysophospholipids and phospholipids for use according to the invention can be notably natural or synthetic compounds, preferably natural. As used herein, synthetic means that the lysophospholipids and phospholipids can be synthesized by chemical way or can be obtained from a natural organism, said organism having been previously modified so that it produces said lysophospholipids and phospholipids. The lysophospholipids, more particularly, can also be obtained by enzymatical way; more specifically still, lysophosphatidylinositol can be obtained by the action of vegetable, bacterial or animal phospholipase A2 on 1,2-diacyl-sn-glycero-3-phospho-(1-D-myo-inositol), or phospatidylinositol, found in the phospholipid fraction of vegetables, such as soya beans (Glycine max), or even animals (bovine liver for example). Egg-derived lysophosphatidylcholine is obtained, e.g., by the action of vegetable, bacterial or animal phospholipase A2, on purified or non-purified egg lecithins. As used herein, the term egg-derived lysophosphatidylcholine also covers homologous molecules, that is to say lysophosphatidylcholines which in position 1 (external) of the glycerol comprise 90% and more of palmitic and/or stearic acids. These molecules can be obtained by total or partial chemical synthesis and also from hydrogenated animal or vegetable (lyso)phospholipids.

According to the invention, they can be purified or partially purified. By partially purified, it is meant that the compounds according to the invention have undergone at least one extraction step from their natural source.

According to the invention, lysophospholipids and phospholipids of the invention can be used alone or as a mixture. These terms mean that a lysophospholipid can be used alone or with one or more other lysophospholipids and/or a phospholipid; likewise, a phospholipid can be used alone or with one or more lysophospholipids.

Among the compounds described above, lysophosphatidylinositol and egg-derived lysophosphatidylcholine are more particularly selected.

The present invention, therefore, concerns the use of lysophospholipids and/or phospholipids for the preparation of a foodstuff composition that has the following advantages:
it can be used as animal or human foodstuff
it has the necessary elements to improve the hydrolysis of dietary lipids,
it can be used alongside food, or as a component of at least one food,
it has neither particular odor or flavor and does not therefore have any additional undesired taste,
it is easy to use,
it is useable in all stages of life, from newborn infants to the elderly, and in healthy subjects or those with clinical conditions (gastric problems, chronic pancreatitis, cystic fibrosis, general lipid absorption problems).

Foodstuff composition, as used herein, means a composition aimed at being administered to humans or animals particularly orally, as an ingredient and/or supplement, thus being able to be used as part of a current daily diet or as clinical nutrition care.

Said foodstuff composition can be in pulverized form, in capsule form, in a tablet form, or other solid form, potentially able to comprise a lipid dispersed in an aqueous phase, or to be in the form of a drinkable solution or suspension.

The composition according to the invention can be in a pure form or in a mixture. Thus, it can comprise other compounds compatible with food, selected from acceptable foodstuff additives, excipients, acidifiers, anti-caking agents, colorants, flavorings, sweeteners.

Advantageously, the composition can be used alongside food or as a component of at least one food.

In an advantageous way, the composition according to the invention can be consumed during a meal, on its own or as a component of at least one food. In a preferred manner, it will be incorporated in or sprinkled onto food.

In practice, foods can be single foods or combination foods, and can be presented in any usual known forms within human and animal diets, normal or assisted.

Food, in the sense of the present invention, is taken to mean any food able to be digested alone or accompanied, solid, in pieces, mixed or liquid, raw or cooked, prepared or not, in any way whatsoever, such as, for example but not limited to, meats or meat products, marine and freshwater products, textured protein products, products based on animal or vegetable protein hydrolysates, milk and dairy products, including milk substitutes, eggs and egg products, fruits and vegetables, cereals and products based on cereals, starchy foods such as pasta and rice, oils, vinegars and condiments, sauces and edible fats, sweet products, jams, jellies, compotes, spreads, sweets, preserves, semi-preserves, soups, coffee, tea, drinks, cakes, cocoa, chocolate, ice cream, meal-substitutes, fresh, frozen or sterilized ready-cooked and prepared meals, bread and bread-making products.

Thus, the composition according to the invention can be a component of a food without altering the taste or constituting stress for the individual (human or animal). It is not like taking a medicine.

The foodstuff composition according to the invention has no interaction with other ingredients. It is resistant to heat and cold as well as to variations in temperature. It can be frozen or heated without loss of properties.

The appropriate quantity of the foodstuff composition according to the invention can vary according to the needs of the individual as well as the number of doses, alone or as a food supplement, that a given individual eats during the day; the recommended dose is around 10 mg to 5 grams of lysophospholipid and/or phospholipid for a person of 70 kg, preferably between 50 mg to 2 grams, and most preferably between 200 mg and 800 mg. The different quantities previously described correspond to the quantities necessary for daily administration. In the case where the administration of the composition according to the invention follows a different dosage, a person skilled in the art will be able to modify without difficulty these quantities to adjust them to said new dosage. For example, a composition according to the invention aimed at one administration per half a day comprises different components previously described in a quantity corresponding to half of the quantities previously described. The dosage can also be adapted to the dietary fat intake as well as the weight of the individual.

The composition according to the invention can be used in mammals, more specifically in humans. It can be administered elderly to or consumed by adults, children and newborn infants. It is particularly suitable for subjects suffering from poor digestion and/or poor absorption and/or those wishing to increase their digestive comfort. The populations to be affected are:
the general population seeking digestive comfort (athletes, pregnant women, etc);
normal subjects during certain critical times of life: premature or full-term newborn infants;
subjects suffering from pancreatic insufficiency of pathological origin who may or may not be receiving enzymatic supplements;
patients or animals having undergone surgical procedures on the digestive tract (partial gastrectomies, intestinal resection, ablation of part of the pancreas, biliary resection);
patients receiving antacid treatment leading to a decrease in the production of gastric lipase;
subjects or animals with diminished lipolytic activity due to genetic polymorphisms or structural fragility of a digestive lipase.

In an advantageous way, one can, according to the invention, prepare a food incorporating an adequate quantity of the foodstuff composition in this food.

It is also one of the aims of the present invention to have a supplemented food, comprising at least one of the foodstuff composition according to the invention.

One can thus, according to the invention, prepare a traditional meal while mixing, for example, by sprinkling, an adequate quantity of the foodstuff composition into the traditional meal.

According to another embodiment, the present invention concerns a method to promote the digestibility of foodstuff lipids comprising administering into the digestive tract, and particularly orally, between 10 mg and 5 grams of lysophospholipid and/or phospholipid according to the invention, possibly every day, per person, preferably between 50 mg and 2 grams and more preferably, between 200 mg and 800 mg. Advantageously, according to the invention, the administration is daily.

The present invention also concerns a method for preparing a food supplemented with the foodstuff composition according to the invention, comprising the following steps:
a food is available
an appropriate quantity of the foodstuff composition according to the invention is incorporated into the food.

According to this method, the incorporation according to the invention can be carried out by mixing or sprinkling the composition according to the invention with or on the already prepared food. It can be carried out by incorporation of the composition according to the invention during the preparation of the food. It can also be taken in the form of supplement during the meal.

Other characteristics of the invention will appear in the examples which follow, without however constituting any limitation of the invention, as well as in the appended figures, in which:

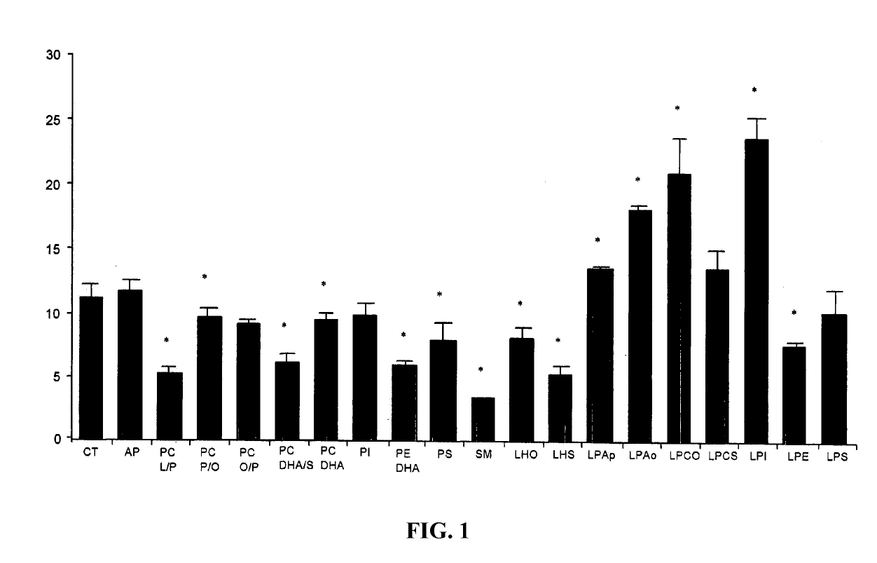

FIG. 1 shows the yield of gastric lipolysis of triolein emulsions, stabilized by different types of phospholipids (CT (control), AP, PC L/P, PC P/O, PC O/P, PC DHA/S, PC DHA, PI, PE DHA, PS, SM, LHO, LHS, LPAp, LPAo, LPCO, LPCS, LPI, LPE, LPS) in the presence of gastric juices of a subject coded BAK;

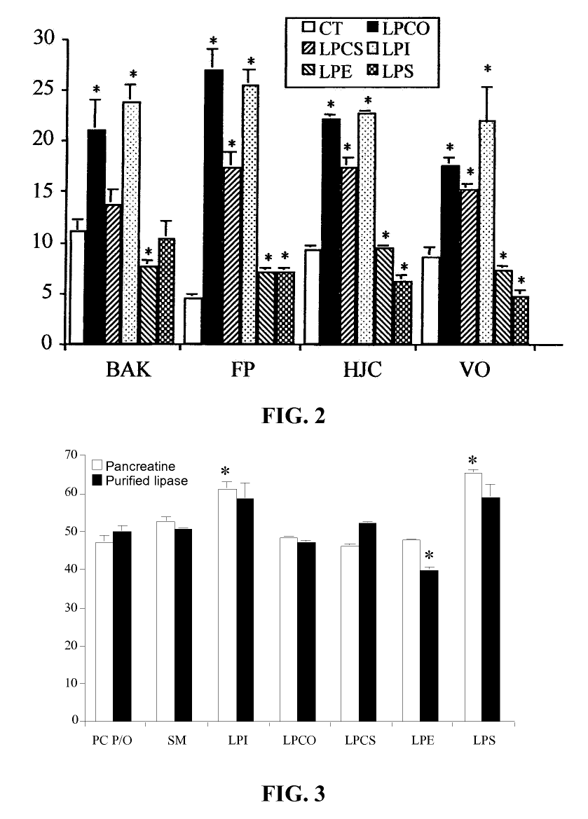

FIG. 2 shows the results obtained in tests of gastric lipolysis of triolein emulsions stabilized by different types of phospholipids (CT (control), LPCO, LPCS, LPI, LPE, LPS) in the presence of different gastric juices of different subjects (codes: BAK, FP, HJC and VO);

FIG. 3 shows the results obtained in tests of intestinal lipolysis of triolein emulsions stabilized by different types of phospholipids (PC P/O (control), SM, LPI, LPCO, LPCS, LPE, LPS) in normal physiological conditions in the presence of purified pancreatic lipase or pancreatine (powder of pig pancreas);

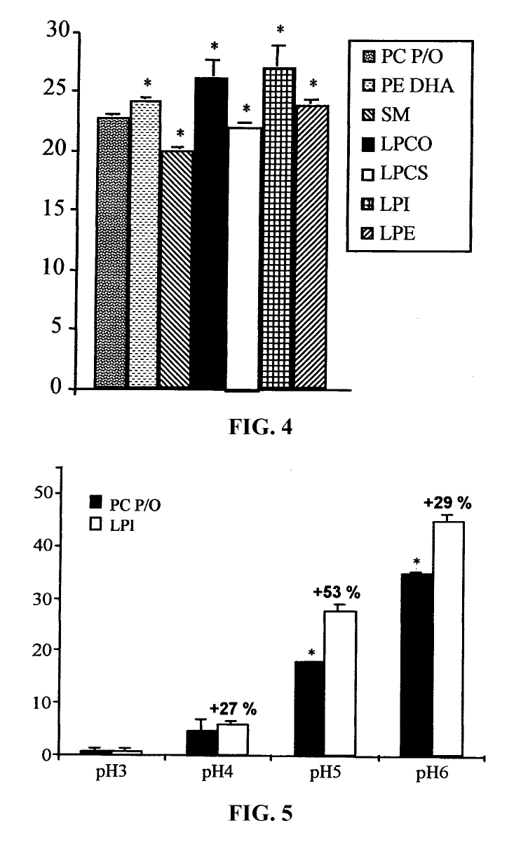

FIG. 4 shows the results obtained in tests of intestinal lipolysis of triolein emulsions stabilized by different types of phospholipids (PC P/O (control), PE DHA, SM, LPCO, LPCS, LPI, LPE) by BSSL (bile salt stimulated lipase) in normal conditions;

FIG. 5 shows the results obtained in tests of intestinal lipolysis of triolein emulsions stabilized by LPI, in comparison with PC P/O, in conditions of pancreatic insufficiency in the presence of colipase-dependent pancreatic Lipase (purified lipase) at different pH values;

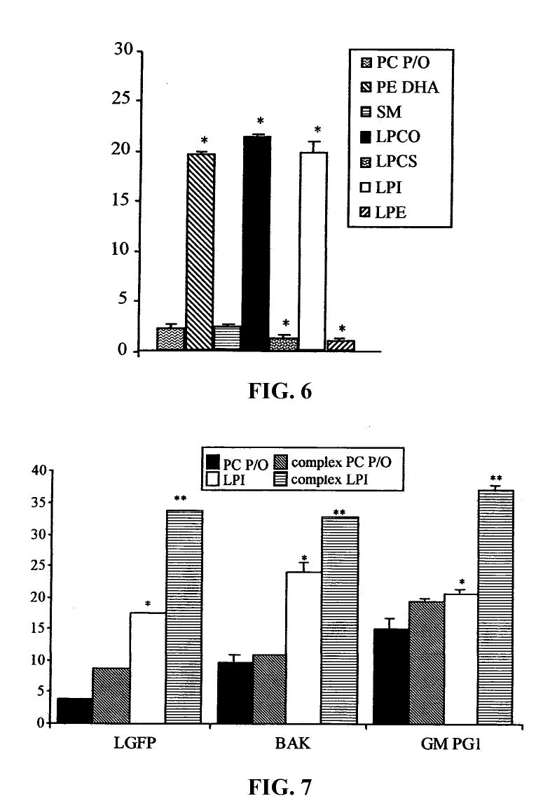

FIG. 6 shows the results obtained in tests of intestinal lipolysis of triolein emulsions stabilized by different types of phospholipids (PC P/O, PE DHA, SM, LPCO, LPCS, LPI, LPE) by bile salt stimulated lipase in conditions of pancreatic insufficiency in the presence of a mixture of pure bile salts (Jarvenpaa et al. Pediatrics 1983; 72: 677-683);

FIG. 7 shows the results obtained in tests of gastric lipolysis by different human juices of PC P/O and LPI emulsions in the presence of lactose and milk proteins (complex emulsions);

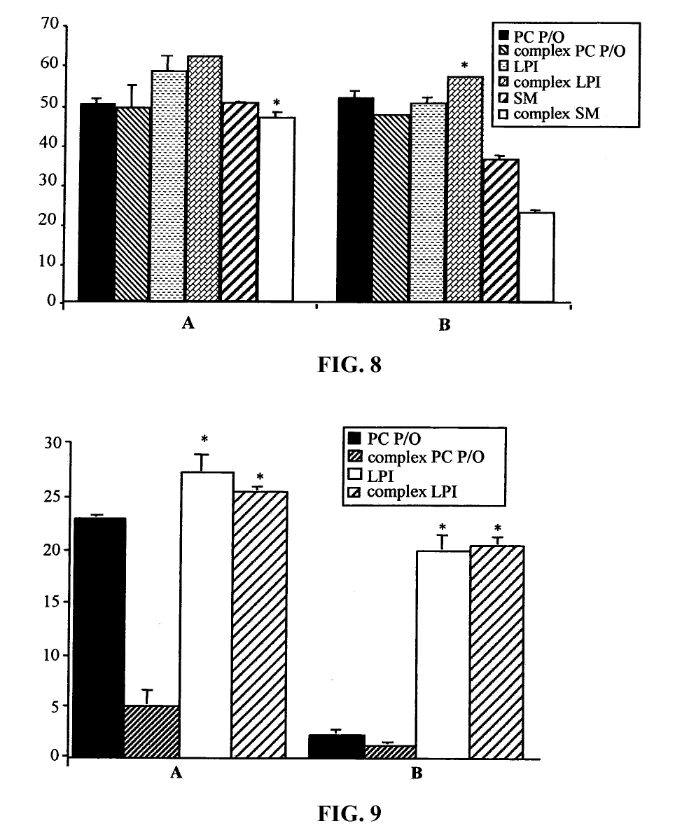

FIG. 8 shows the results obtained in tests of intestinal lipolysis of triolein emulsions, stabilized by different types of phospholipids (PC P/O, LPI and SM), by purified pancreatic lipase in the presence of lactose and milk proteins (complex emulsions), in normal conditions (A) or in conditions of pancreatic insufficiency (B);

FIG. 9 shows the results obtained in tests of intestinal lipolysis of triolein emulsions, stabilized by different types of phospholipids (PC P/O, LPI), by bile salt stimulated lipase (BSSL) in the presence of lactose and milk proteins (complex emulsions), in normal conditions (A) or in conditions of pancreatic insufficiency (B);

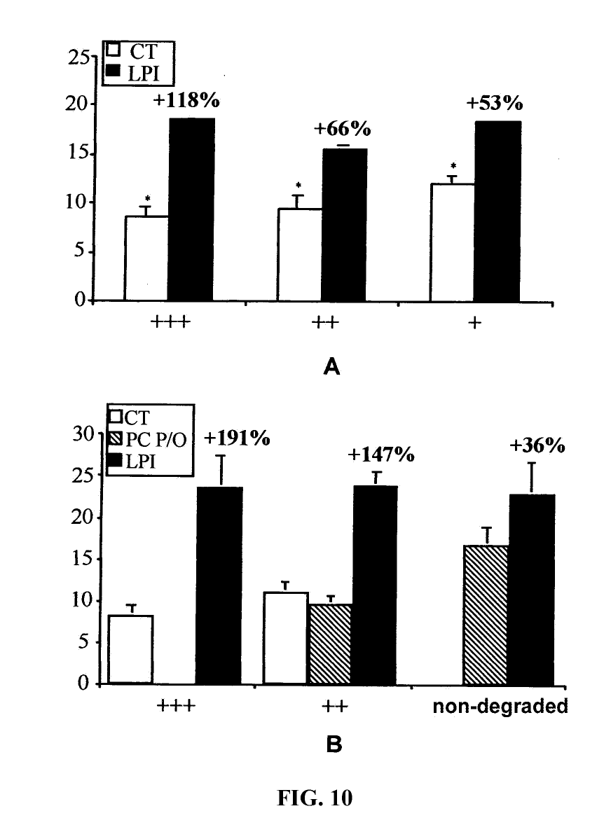

FIG. 10 shows the relationship between the improvement of the yield of gastric lipolysis by LPI and the state of degradation of the N-terminal end of the purified gastric lipases (A) or of juices of different subjects (B), by comparison with the control CT and/or PC P/O;

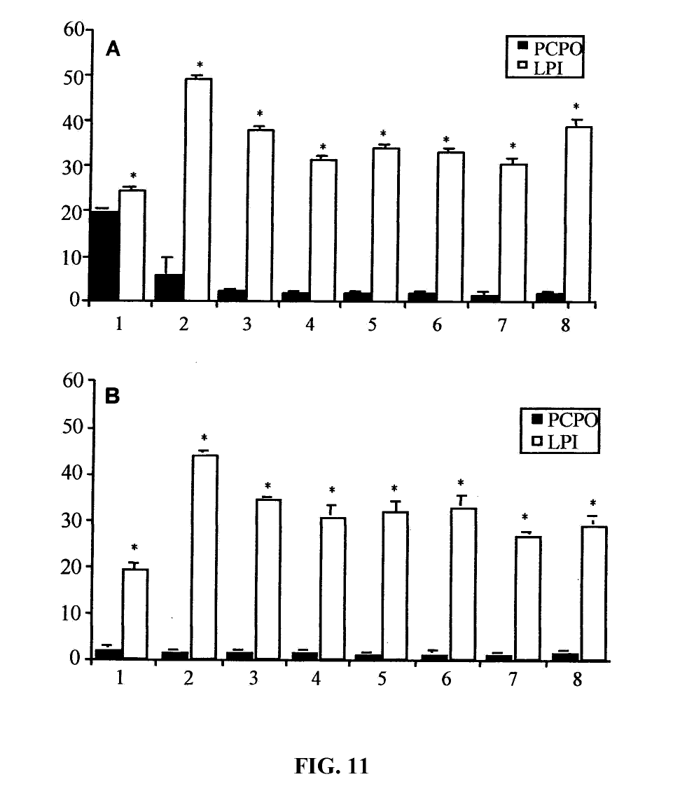

FIG. 11 shows the results obtained in tests of intestinal lipolysis of LPI emulsion by different bile salt stimulated lipases (1 to 8) in normal conditions (A) or in conditions of pancreatic insufficiency (B), by comparison with the control PC P/O;

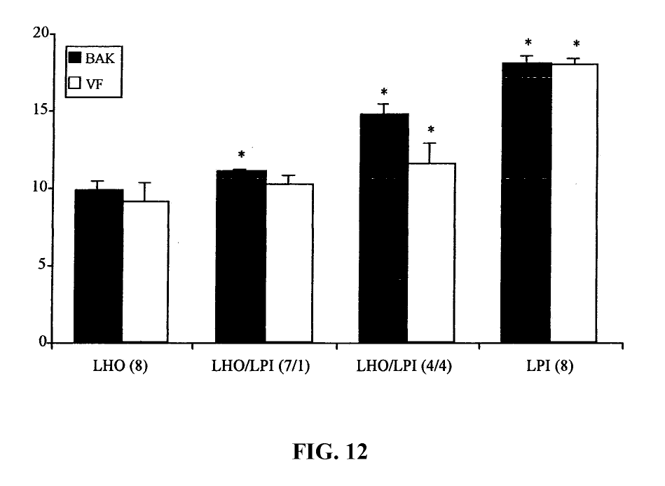

FIG. 12 shows the effects of the dose of LPI on the yield of gastric lipolysis of the LHO emulsion for two gastric juices belonging to two different subjects (subjects BAK and VF).

### EXAMPLE

### Search for Lysophospholipids and Phospholipids Improving the Bioavailability of Lipids in Subjects with Problems of Poor Digestion and Poor Absorption

Materials and Methods:

Tested compounds: The compounds tested are as follows:

CT, mixture of egg phospholipids used as a control, containing PC, PE, PS, PI and SM;

AP, phosphatidic acid;

PC L/P, linoleyl palmitoyl phosphatidylcholine;

PC P/O, palmitoyl oleoyl phosphatidylcholine;

PC O/P, oleoyl palmitoyl phosphatidylcholine;

PC DHA/S, DHA stearoyl phosphatidylcholine;

PC DHA, phosphatidylcholine from avian origin enriched in DHA;

PI, phosphatidylinositol;

PE DHA, DHA phosphatidylethanolamine;

PS, phosphatidylserine;

SM, sphingomyelin;

LHO, mixture of bird-derived phospholipids close to the composition of breast milk;

LHS, mixture of soy-derived phospholipids close to the composition of breast milk;

LPAp and LPAo, palmitic or oleyl lysophosphatidic acids;

LPCO, egg-derived lysophosphatidylcholine containing palmitic and stearic acids at more than 90%; LPCS, soy-derived lysophosphatidylcholine;

LPI, lysophosphatidylinositol;

LPE, lysophosphatidylethanolamine;

LPS, lysophosphatidylserine.

Methods

The compounds have been tested in vitro in different experimental conditions for their ability to promote the action of three major lipolytic enzymes of the digestive tract, i.e., gastric lipase, colipase-dependent pancreatic lipase, bile salt stimulated lipase (BSSL), and their isoforms and variants.

Different lipidic emulsions have been prepared by sonication of a mixture of triolein (TO) (98.7%), cholesterol (0.5%) and phospholipids (0.8%).

The lipolysis tests have been carried out in vitro in conditions that mimic the physiology of the human digestive tract, either healthy or with pancreatic insufficiency (PI).

Gastric lipolysis in the presence of gastric lipase has been carried out with purified lipases or gastric juices from different subjects at pH 5.40, at 37° C. for 60 minutes with a gastric lipase (U/mL)/lipids (micromoles of TO) ratio of 2.

Intestinal lipolysis in the presence of colipase dependent pancreatic lipase (lipase/colipase 1/1 molar ratio) or of pig pancreatic extract (pancreatine) was conducted at pH 7 to 3 at 37° C. for 15 minutes, with a pancreatic lipase (U/mL)/micromoles of TO ratio of 20, and in the presence of pig bile in sufficient quantity for a bile salt concentration of 2 or 8 mM.

Intestinal lipolysis in the presence of BSSL has been carried out at pH 7 at 37° C. for 15 minutes using a BSSL/TO ratio close to the ratio found in breast milk, in the presence of pig bile or of an artificial mixture of bile salts (close to the bile salt composition of newborn infants) in sufficient quantity to give a bile salt concentration of 2.5 or 8 mM. Several variants of BSSL have been tested, numbered 1 to 8.

Lipolysis by the three main digestive tract lipases has also been tested in more complex conditions, i.e. in the presence of lipidic emulsions with a mixture of proteins plus lactose added in proportions that are found in normal or medically assisted nutrition.

### Example 1

### Effect of Different Phospholipids on the Three Main Digestive Lipolytic Enzymes of the Gastro-Intestinal Tract in Conditions of a Healthy Subject

Gastric Lipase (FIGS. 1 and 2)

FIG. 1 shows the yield of gastric lipolysis of triolein emulsions, stabilized by different types of phospholipids (CT (control), AP, PC L/P, PC P/O, PC O/P, PC DHA/S, PC DHA, PI, PE DHA, PS, SM, LHO, LHS, LPAp, LPAo, LPCO, LPCS, LPI, LPE, LPS) in the presence of gastric juices of a subject coded BAK.

The results of the digestion tests are shown in FIG. 1. The percentage of hydrolysis is on the Y-axis.

The asterisk (*) indicates the yields of gastric lipolysis that are significantly different to that of the CT emulsion. Mean±SEM.

These results show that the yields of gastric lipolysis obtained with LPAo, LPCO and LPI are significantly higher than those obtained with the control.

FIG. 2 shows the results obtained in tests of gastric lipolysis of triolein emulsions stabilized by different types of phospholipids (CT (control), LPCO, LPCS, LPI, LPE, LPS) in the presence of different gastric juices from different subjects (codes: BAK, FP, HJC and VO). The percentage of hydrolysis is on the Y-axis.

The asterisk (*) indicates the yields of gastric lipolysis that are significantly different to that of the CT emulsion. Mean±SEM.

These results show that the yield of gastric lipolysis obtained with LPI and LPCO is significantly higher than that obtained with the control irrespective of the origin of gastric juice.

Colipase Dependent Pancreatic Lipase (FIG. 3)

FIG. 3 shows the results obtained in tests of intestinal lipolysis of triolein emulsions stabilized by different types of phospholipids (PC P/O, SM, LPI, LPCO, LPCS, LPE, LPS) in normal physiological conditions in the presence of purified pancreatic lipase or pancreatine (powder of pig pancreas). The percentage of hydrolysis is on the Y-axis.

The asterisk (*) indicates the yields of pancreatic lipolysis that are significantly different to that obtained with the PC P/O emulsion. These results show that the yields of pancreatic lipolysis obtained with two forms of pig pancreatic lipase (pure lipase or powder of pancreas) are significantly higher in the presence of LPI and LPS than that obtained with PC P/O.

Bile Salt Stimulated Lipase (BSSL) (FIG. 4)

FIG. 4 shows the results obtained in tests of intestinal lipolysis of triolein emulsions stabilized by different types of phospholipids (PC P/O (control), PE DHA, SM, LPCO, LPCS, LPI, LPE) by BSSL bile salt stimulated lipase in normal conditions. The percentage of hydrolysis is on the Y-axis.

The asterisk (*) indicates the yields of lipolysis by BSSL that are significantly different to that obtained with the PC P/O emulsion.

These results show that the yields of lipolysis by BSSL obtained with PE DHA, LPCO and LPI are significantly higher than that obtained with PC P/O.

### Example 2

### Activator Effect of Lysophosphatidylinositol (LPI) on Digestive Lipolytic Enzymes of the Intestinal Tract in Conditions of Pancreatic Insufficiency

Colipase Dependent Pancreatic Lipase (FIG. 5)

FIG. 5 shows the results obtained in tests of intestinal lipolysis of triolein emulsions stabilized by LPI, in comparison with PC P/O, in conditions of pancreatic insufficiency in the presence of colipase dependent pancreatic Lipase (purified lipase) at different pH values. The percentage of hydrolysis is on the Y-axis.

These results show that the yields of pancreatic lipolysis obtained with LPI are significantly higher than those obtained with PC P/O for intestinal pH values typically found in patients suffering from pancreatic insufficiency.

Bile Salt Stimulated Lipase (BSSL) (FIG. 6)

FIG. 6 shows the results obtained in tests of intestinal lipolysis of triolein emulsions stabilized by different types of phospholipids (PC P/O, PE DHA, SM, LPCO, LPCS, LPI, LPE) by the BSSL in conditions of pancreatic insufficiency in the presence of a mixture of pure bile salts (Jarvenpaa et al. Pediatrics 1983; 72: 677-683).

The percentage of hydrolysis is shown on the Y-axis.

The asterisk (*) indicates the significantly different values to that obtained with the PC P/O emulsion.

These results show that the yields of lipolysis by BSSL obtained with PE DHA, LPCO and LPI are significantly higher than those obtained with PC P/O.

### Example 3

### Activator Effect of Lysophosphatidylinositol (LPI) on the Three Main Digestive Lipolytic Enzymes of the Gastro-Intestinal Tract in Normal Conditions or Conditions of Pancreatic Insufficiency in the Presence of a Complex Environment (Dietary Proteins, Lipids and Carbohydrates (Lactose))

The activator effect of LPI is identical or even maximized in the presence of a mixture of protein plus lactose for the three lipases.

Gastric Lipase (FIG. 7)

FIG. 7 shows the results obtained in tests of gastric lipolysis by different human juices of PC P/O and LPI emulsions in the presence of lactose and milk proteins (complex emulsions).

The percentage of hydrolysis is on the Y-axis.

The asterisk (*) indicates a yield of gastric lipolysis that is significantly different to that obtained with the PC P/O emulsion.

Two asterisks (**) indicate the yield of gastric lipolysis that is significantly different to that obtained with the complex PC P/O.

These results show that the yields of gastric lipolysis obtained with LPI and complex LPI are significantly higher compared with PC P/O and complex PC P/O irrespective of the origin of gastric juice.

Pancreatic Lipase (FIG. 8)

FIG. 8 shows the results obtained in tests of intestinal lipolysis of triolein emulsions, stabilized by different types of phospholipids (PC P/O, LPI and SM), by purified pancreatic lipase in the presence of lactose and milk proteins (complex emulsions).

The digestion tests have been carried out at pH 7.00 with purified pig pancreatic lipase in the presence of normal bile salt concentration (8 mM, A) or low bile salt concentration (2 mM, pancreatic insufficiency, B). The percentage of hydrolysis is on the Y-axis.

The asterisk (*) indicates a value significantly different to that obtained without lactose or protein.

These results show that the yields of pancreatic lipolysis obtained with complex LPI are significantly higher than with complex PC P/O in the presence of a low concentration of bile salts.

BSSL Lipase (FIG. 9)

FIG. 9 shows the results obtained in tests of intestinal lipolysis of triolein emulsions, stabilized by different types of phospholipids (PC P/O, LPI), by BSSL in the presence of lactose and milk proteins (complex emulsions). The digestion tests have been carried out at pH 7.00 with purified human BSSL in the presence of normal bile salt concentration (8 mM, A) or low bile salt concentration (2 mM, pancreatic insufficiency, B). The percentage of hydrolysis is on the Y-axis.

The asterisk (*) indicates a significantly different value between the two phospholipids tested.

These results show that the yields of lipolysis by BSSL obtained with LPI and complex LPI are significantly higher than those obtained with PC P/O and complex PC P/O.

### Example 4

### Activator Effect of Lysophosphatidylinositol LPI on Different Forms Of Human Gastric Lipase and on Different Forms of BSSL

Gastric Lipase (FIG. 10)

FIG. 10 shows the relationship between the improvement in the yield of gastric lipolysis by LPI and the extent of degradation of the N-terminal end of purified gastric lipases (A) or of juices from different subjects (B), by comparison with the control CT and/or PC P/O.

The percentage of hydrolysis is on the Y-axis.

The gastric lipases used show different degrees of degradation of their N-terminal ends (+), and the number of (+) on the X-axis increases with the extent of this degradation. LPI reactivates degraded gastric lipase at its N-terminal level. The more the lipase is degraded, the more significant the reactivation.

BSSL (FIG. 11)

FIG. 11 shows the results obtained in tests of intestinal lipolysis of LPI emulsion by different bile salt stimulated lipases (1 to 8) in normal conditions (A) or in conditions of pancreatic insufficiency (B), by comparison with the control PC P/O. The asterisk (*) shows a yield of lipolysis that is significantly different between phospholipids. The percentage of hydrolysis is on the Y-axis.

The activator effect of LPI is confirmed for different variants of BSSL but its efficacy varies according to the type of BSSL in normal conditions (A) or conditions of pancreatic insufficiency (B).

### Example 5

### The activator effect of LPI is dose dependent and seems optimal for a low quantity, i.e., 0.8% of total lipids

FIG. 12 shows the effects of the dose of LPI on the yield of gastric lipolysis of the LHO emulsion for two gastric juices from two different subjects (subjects BAK and VF). The percentage of hydrolysis is on the Y-axis.

The asterisk (*) shows a significantly different value to that of the LHO emulsion (mixture of phospholipids in proportions found in breast milk). The figure in brackets shows the ratio between LHO and LPI. The total concentration of phospholipids is 0.8% of the total lipids. These results show that the yields of gastric lipolysis increase with increasing concentrations of LPI (0.1; 0.4 and 0.8% of total lipids) and that the magnitude of the increase as a function of the lowest LPI concentrations is dependent on the subject (BAK versus VF).

### CONCLUSION

The study of the impact of different natural tensioactive agents on the efficacy of lipolysis in an in vitro model close to physiological conditions has shown the ability of LPI to promote lipolysis of emulsions that contain it in different digestive tract conditions (gastric and duodenal) representative of conditions mimicking both different types of meals and different clinical cases (full-term or premature newborn, chronic pancreatitis, cystic fibrosis, elderly).

In particular, in the presence of LPI, some lipidic emulsions normally only very slightly hydrolysable by weakly active gastric lipase coming from subjects secreting a partially degraded form of gastric lipase, show hydrolysis rates practically comparable to those measured in the presence of non-degraded human gastric lipase.

Thus LPI allows the lipidic emulsion to have the structure most suitable to being hydrolyzed and makes fully functional the gastric lipases that are quasi-inactive due to depletion of certain NH2-terminal amino acids, which have been described as playing a significant role in the fixation of the enzyme to its lipidic substrate.

In a surprising as well as interesting way, LPI always exerts an activator effect of different magnitude according to the type of BSSL variant.

In an unexpected way, LPI is the best activator of the three main gastrointestinal lipolysis enzymes in each of the conditions tested.

LPCO seems to be the second molecule of interest.

1-11. (canceled)

12. A food supplement intended for human or animal food, comprising a lysophospholipid, a phospholipid, or a mixture of said lysophospholipid and said phospholipid; wherein said lysophospholipid and said phospholipid are selected from lysophosphatidylinositol, oleyl lysophosphatidic acid, lysophosphatidylserine, egg-derived lysophosphatidylcholine and phosphatidylethanolamine DHA; said lysophospholipid and said phospholipid are purified or partially-purified; and said supplement is useful for improving digestibility of lipids.

13. The food supplement of claim 12, wherein said lysophospholipid and phospholipid are natural or synthetic compounds.

14. The food supplement of claim 12 comprising lysophosphatidylinositol, egg-derived lysophosphatidylcholine, or a mixture of lysophosphatidylinositol and egg-derived lysophosphatidylcholine.

15. The food supplement of claim 12 formulated as a unit dose comprising between 10 mg and 5 grams of said lysophospholipid, said phospholipid, or said mixture of said lysophospholipid and said phospholipid.

16. The food supplement of claim 15 formulated as a unit dose comprising between 50 mg and 2 grams of said lysophospholipid, said phospholipid, or said mixture of said lysophospholipid and said phospholipid.

17. The food supplement of claim 16 formulated as a unit dose comprising between 200 mg and 800 mg of said lysophospholipid, said phospholipid, or said mixture of said lysophospholipid and said phospholipid.

18. A food supplement composition comprising the food supplement of claim 12 and at least one of the following: nutritionally-acceptable foodstuff additive, excipient, acidifier, anti-caking agent, colorant, flavoring, or sweetener.

19. Food comprising the food supplement of claim 12.

20. Food comprising the food supplement composition of claim 18.

21. A method for improving digestibility of foodstuff lipids, comprising adding to food an effective dose of the food supplement of claim 12.

22. A method for improving digestibility of foodstuff lipids, comprising adding to food an effective dose of the food supplement composition of claim 18.

23. A method for improving digestibility of foodstuff lipids, comprising administering to a person or an animal an effective dose of the food supplement of claim 12.

24. The method of claim 23, wherein said food supplement is administered orally in an amount of between 10 mg and 5 grams of said lysophospholipid, said phospholipid, or said mixture of said lysophospholipid and said phospholipid per person or per animal per day.

25. The method of claim 23, wherein said food supplement is administered orally in an amount of between 50 mg and 2 grams of said lysophospholipid, said phospholipid, or said mixture of said lysophospholipid and said phospholipid per person or per animal per day.

26. The method of claim 23, wherein said food supplement is administered orally in an amount of between 200 mg and 800 mg of said lysophospholipid, said phospholipid, or said mixture of said lysophospholipid and said phospholipid per person or per animal per day.

27. A method for improving digestibility of foodstuff lipids, comprising administering to a person or an animal an effective dose of the food supplement composition of claim 18.

28. The method of claim 27, wherein said food supplement composition is administered orally in an amount corresponding to between 10 mg and 5 grams of said lysophospholipid, said phospholipid, or said mixture of said lysophospholipid and said phospholipid per person or per animal per day.

29. The method of claim 27, wherein said food supplement composition is administered orally in an amount corresponding to between 50 mg and 2 grams of said lysophospholipid, said phospholipid, or said mixture of said lysophospholipid and said phospholipid per person or per animal per day.

30. The method of claim 27, wherein said food supplement composition is administered orally in an amount corresponding to between 200 mg and 800 mg of said lysophospholipid, said phospholipid, or said mixture of said lysophospholipid and said phospholipid per person or per animal per day.
